(19) United States
(12) Patent Application Publication
(10) Pub. No.: US 2015/0101195 A1
(43) Pub. Date: Apr. 16, 2015

(54) SHAVING CARTRIDGES HAVING LUBRICATION MEMBERS

(71) Applicant: The Gillette Company, Boston, MA (US)

(72) Inventors: Matthew Michael Long, Methuen, MA (US); Michael Hal Bruno, Burlington, MA (US)

(21) Appl. No.: 14/446,392

(22) Filed: Jul. 30, 2014

Related U.S. Application Data
(60) Provisional application No. 61/889,879, filed on Oct. 11, 2013.

(51) Int. Cl. B26B 21/40; B26B 21/44

(52) U.S. Cl. CPC B26B 21/4025; B26B 21/4018; B26B 21/443
USPC 30/41.5; 30/50

(57) ABSTRACT

A shaving razor cartridge with a housing having a guard toward a front of the housing and a cap toward a rear of the housing. The cap has a crest. A leading blade is mounted to housing nearest the guard and a trailing blade mounted to the housing nearest the cap. Each blade has a blade edge. The blades define a blade plane tangent to the edge of the leading blade and the edge of the trailing blade. The cap having a cap span from the edge of the trailing blade to the crest and a cap height from the crest to the blade plane. A ratio of the cap span to the cap height is about 25:1 to about 70:1.

### FIELD OF THE INVENTION

The present invention relates to shaving razors and more particularly to shaving razor cartridges having a housing and a lubrication member secured to the housing.

### BACKGROUND OF THE INVENTION

In general, shaving razors of the wet shave type include a cartridge or blade unit with at least one blade with a cutting edge, which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled. Razor cartridges usually include a guard which contacts the skin in front of the blade(s) and a cap for contacting the skin behind the blade(s) during shaving. The cap and guard aid in establishing the so-called “shaving geometry”, i.e., the parameters which determine the blade orientation and position relative to the skin during shaving, which in turn have a strong influence on the shaving performance and efficacy of the razor. The guard may be generally rigid, for example formed integrally with a frame or platform structure that provides a support for the blades.

In the use of shaving razors of the wet shave type, factors such as frictional drag of the razor across the skin, force needed to sever hairs, and irritation or pre-existing skin damage can create a degree of shaving discomfort. Shaving aids, e.g., a lubricant, whisker softener, razor cleanser, medicinal agent, cosmetic agent or combination thereof, have been incorporated into razors, for example by incorporating a shaving aid into one or more extruded or molded polymeric components of the razor. Such shaving aid composites may be mounted on the cap or guard structures of the razor cartridge. Upon exposure to water, water-soluble shaving aid leaches from the composite onto the skin and the composite tends to swell.

Three, four, five and six bladed razor cartridges have been developed in an effort to provide a closer and more efficient shave. In addition, the blades have been designed sharper and stronger to reduce the tugging and pulling of the hair as it is cut. However, a certain population of shavers have sensitive skin which may be prone to discomfort, irritation or even nicks and cuts, which may be a result of more aggressive blade designs. Thus there is a need to improve the current shaving experience without negatively impacting closeness. The wet shaving razor cartridge assembly, is preferably simpler, cost-effective, reliable, durable, easier and/or faster to manufacture, and easier and/or faster to assemble with more precision.

### SUMMARY OF THE INVENTION

In one aspect, the invention features, in general, a shaving razor cartridge comprising with a housing having a guard toward a front of the housing and a cap toward a rear of the housing. The cap has a crest. A leading blade is mounted to housing nearest the guard and a trailing blade mounted to the housing nearest the cap. Each blade has a blade edge. The blades define a blade plane tangent to the edge of the leading blade and the edge of the trailing blade. The cap having a cap span from the edge of the trailing blade to the crest and a cap height from the crest to the blade plane. A ratio of the cap span to the cap height is about 25:1 to about 70:1.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1 is front perspective view of one possible embodiment of a shaving blade unit.

FIG. 2 is schematic cross section view of the shaving blade unit, taken generally along the line 2-2 of FIG. 1.

FIG. 3 is schematic cross section schematic view of another possible embodiment of a shaving blade unit.

FIG. 4 is schematic cross section schematic view of another possible embodiment of a shaving blade unit.

FIG. 5 is schematic cross section schematic view of another possible embodiment of a shaving blade unit.

FIG. 6 is schematic cross section schematic view of another possible embodiment of a shaving blade unit.

FIG. 7 is schematic cross section schematic view of another possible embodiment of a shaving blade unit.

FIG. 8 is schematic cross section schematic view of another possible embodiment of a shaving blade unit.

### DETAILED DESCRIPTION OF THE INVENTION

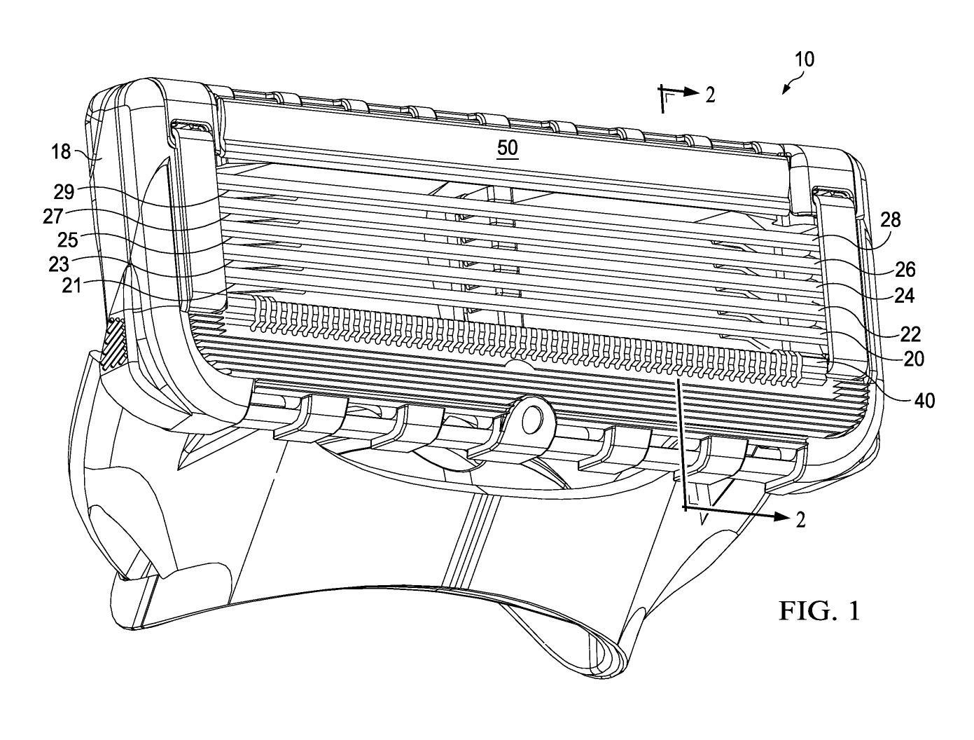

Referring to FIG. 1, one possible embodiment of the present disclosure is shown illustrating a shaving blade unit 10. In certain embodiments, the shaving blade unit 10 may be detached and removed from a handle (not shown). The shaving blade unit 10 may be fixedly or pivotably mounted to the handle depending on the overall desired cost and performance. The shaving blade unit 10 may also include an interconnect member (not shown) to which the shaving blade unit 10 is pivotably mounted about a pivot axis. The shaving blade unit 10 may include a housing 18 that carries one more blades 20, a guard 40, and a cap 50. The one or more blades 20, 22, 24, 26, 28 may be positioned between the guard 40 and the cap 50. For example, FIG. 1 illustrates a cartridge having five blades 20, 22, 24, 26, 28. However, it is understood that more or less blades may be used depending on the desired performance and cost of the shaving blade unit 10. Each blade 20, 22, 24, 26, 28 may have a respective blade edge 21, 23, 25, 27, 29 extending parallel to the cap 50 and the guard 40. In certain embodiments, an elastomeric member 35 may be mounted to the housing 18 in front of the guard 40. The guard 40 may be segmented, as shown, or may be a continuous bar.

In certain embodiments, the housing 18 may be molded from Noryl™ (a blend of polyphenylene oxide (PPO) and polystyrene developed by General Electric Plastics, now SABIC Innovative Plastics). The housing 18 may be molded from other semi-rigid polymers having a Shore A hardness of about 50, 60, or 70 to about 90, 110, or 120. The cap 50 may be a separate molded component that is mounted to the housing 18. The cap 50 may be molded from a lubricious shaving aid composite that has one or more water-leachable shaving aid materials to provide increased comfort during shaving. The shaving aid composite may include one or more skin lubricating water-soluble polymers such as, polyethylene oxide, polyvinyl pyrrolidone, polyacrylamide, hydroxypropyl cellulose, polyvinyl imidazoline, and polyhydroxyethylmethacrylate. Other water-soluble polymers may include the polyethylene oxides generally known as POLYOX (available from Dow Chemical) or ALKOX (available from Meisei Chemical Works, Kyota, Japan). These polyethylene oxides may have molecular weights of about 100,000 to 6 million, for example, about 300,000 to 5 million. The polyethylene oxide may comprises a blend of about 40 to 80% of polyethylene oxide having an average molecular weight of about 5 million (e.g., POLYOX COAGULANT) and about 60 to 20% of polyethylene oxide having an average molecular weight of about 300,000 (e.g., POLYOX WSR-N-750). The polyethylene oxide blend may also contain up to about 10% by weight of a low molecular weight (i.e., MW<10,000) polyethylene glycol such as PEG-100.

The shaving aid composite may also optionally include an inclusion complex of a skin-soothing agent with a cylcodextrin, low molecular weight water-soluble release enhancing agents such as polyethylene glycol (e.g., 1-10% by weight), water-swellable release enhancing agents such as cross-linked polyacrylics (e.g., 2-7% by weight), colorants, antioxidants, preservatives, microbicidal agents, beard softeners, astringents, depilatories, medicinal agents, conditioning agents, moisturizers, cooling agents, etc.

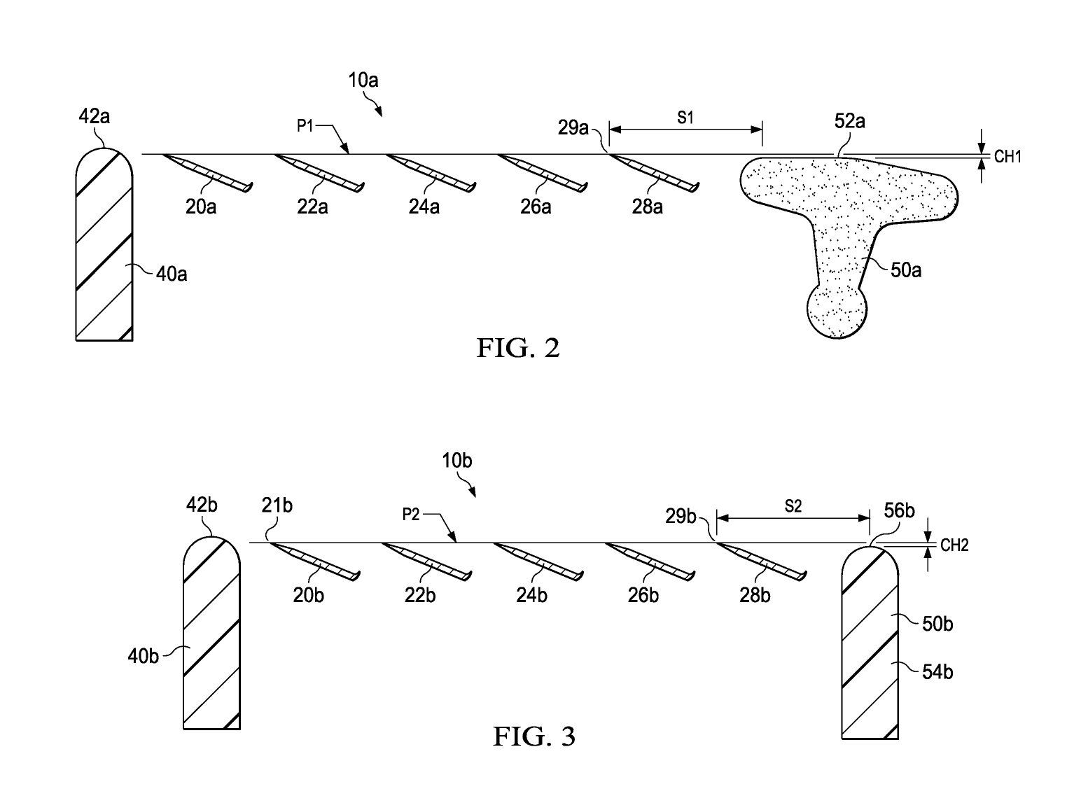

Referring to FIG. 2, a schematic view of one possible embodiment of the shaving blade unit 10a is shown. For clarity similar structures are illustrated as having the same numeric reference, but with a different alphabetical reference to denote a different embodiment. The guard 40a may have an apex 42a (i.e., the highest point of the guard 42). The leading blade 20a may be mounted to the housing 18 (not shown) nearest the guard 40a. A trailing blade 28a may be mounted to the housing nearest the cap 50a. One or more intermediate blades 22a, 24a and 26a may be mounted to the housing 18 between the leading blade 20a and the trailing blade 28a. The blades 20a, 22a, 24a, 26a, 28a may be sprung mounted or fixed to the housing 18. The cap 50a may have a crest 52a (i.e., the highest point of the cap 50a).

The leading blade 20a and the trailing blade 28a may define a blade plane “P1” tangent to the blade edge 21a of the leading blade 20a and the blade edge 29a of the trailing blade 28a. The cap 50a may have a cap span “S1” from the blade edge 29a of the trailing blade 28a to the crest 52a of the cap 50. The cap span S1 may be taken from the point of the crest 52a that is nearest the trailing blade 28a, for example, if there are multiple crests having the same height, or if the crest 52a is long and flat. The cap 50 may have a cap height “CH1” from the crest 52a to the blade plane P1, wherein a ratio of the cap span S1 to the cap height CH1 may be about 25 to about 70 (i.e., cap span S1 divided by cap height CH1).

In certain embodiments, the ratio of the cap span S1 to the cap height CH1 may be about 35 to 45 and more preferably about 38 to 42. In certain embodiments, the ratio of the cap span S1 to the cap height CH1 may be expressed as an absolute number. Accordingly, the crest 52a may be above the blade plane P1 or below the blade plane P1, but may have the same ratio. For example, for all the embodiments described herein, the cap span may be about 1.9 mm to about 3.0 mm and the cap height may be about −0.3 mm to about −0.05 mm (negative being below the blade plane P1) to arrive at the determined ratio of about 25 to about 70, preferably about 35 to 45 and more preferably about 38 to 42.

It is believed, without being held to theory, the ratio of the ratio of the cap span S1 to the cap height CH1, which are determined by the blade closest to the cap 50, dictates the ultimate comfort and closeness performance vectors of a shaving blade unit. For example, if the ratio of the cap span S1 to the cap height CH1 is too high or too low the trailing blade 28a may be de-loaded, putting more pressure on the other blades (possibly resulting in discomfort and irritation from increased nicks and cuts) or the trailing blade may be overloaded, which may cause the trailing blade 28a to assert more pressure against the skin increasing, nicks, cuts, irritation and discomfort. Furthermore, if the trailing blade is de-loaded too much, the trailing blade 28a may not even contact the skin, thus resulting in a significant amount of missed hairs.

In certain embodiments the cap 50a (e.g., the crest 52a of the cap 50) may comprise a lubrication member comprising a water soluble polymer. For example, the cap 50a may be extruded or injection molded from a combination of one or more water-soluble polymers (e.g., polyethylene oxides generally known as POLYOX (available from Dow Chemical)) and a non water soluble polymer (e.g., high impact polystyrene). Since the water soluble polymer may swell depending on its composition, the geometry (e.g., the ratio of the cap span S1 to the cap height CH1) is typically taken in a dry condition (e.g., prior to use). In certain embodiments, the ratio of the cap span S1 to the cap height CH1 may be about 25 to about 70, about 35 to about 45 about 38 about to about 42 in both the dry condition (e.g., prior to shaving). Accordingly, the shaving blade unit 10 may produce a close, comfortable shave at the very beginning of the shave and toward the end of the shave after the cap 24 has absorbed water and swelled.

Referring to FIG. 3, a schematic view of another possible embodiment of a shaving blade unit 10b is shown. The shaving blade unit 10b may be similar to the shaving blade unit 10a shown in FIGS. 1 and 2; however the shaving blade unit 10b may have a cap 50b that comprises a cap rail 54b. The cap rail 54b may be manufactured from metal or plastic. In certain embodiments, the cap rail 54b may be part of the housing 18 (not shown) or a separate component. The shaving blade unit 10b may include a guard 40b having an apex 42b (i.e., the highest point of the guard 40b). A leading blade 20b may be mounted to the housing 18 (not shown) nearest the guard 40b. A trailing blade 28b may be mounted to the housing nearest the cap rail 50b. The cap rail 54b may have a crest 56b (i.e., the highest point of the cap rail 54b). One or more intermediate blades 22b, 24b, 26b may be mounted to the housing 18 between the leading blade 20b and the trailing blade 28b. The blades 20b, 22b, 24b, 26b and 28b may be sprung mounted or fixed to the housing 18. The leading blade 20b and the trailing blade 28b may define a blade plane “P2” tangent to the blade edge 21b of the leading blade 20b and the blade edge 29b of the trailing blade 28b.

The cap rail 54b may have a cap span “S2” from the blade edge 29b of the trailing blade 28b to the crest 56b of the cap rail 54b. The cap span S2 may be taken from the point of the crest 56b that is nearest the trailing blade 28b, for example, if there are multiple crests having the same height, or if the crest 56b is long and flat. The cap rail 54b may have a cap height “CH2” from the crest 56b to the blade plane P2, wherein a ratio of the cap span S2 to the cap height CH2 may be about 25 to about 70 (i.e., cap span S2 divided by cap height CH2).

In certain embodiments, the ratio of the cap span S2 to the cap height CH2 may be about 35 to 45 and more preferably about 38 to 42. In certain embodiments, the ratio of the cap span S2 to the cap height CH2 may be expressed as an absolute number. Accordingly, the crest 56b may be above the blade plane P2 or below the blade plane P2, but may have the same ratio. It is believed, without being held to theory, the ratio of the ratio of the cap span S2 to the cap height CH2, provides similar shaving benefit as previously described. The cap rail 54b may have the additional benefit of maintaining the ratio of the cap span S2 to the cap height CH2 throughout the life of the shaving blade unit. For example, the cap height CH1 may decrease with use as the crest 52b gradually wears away after each shave.

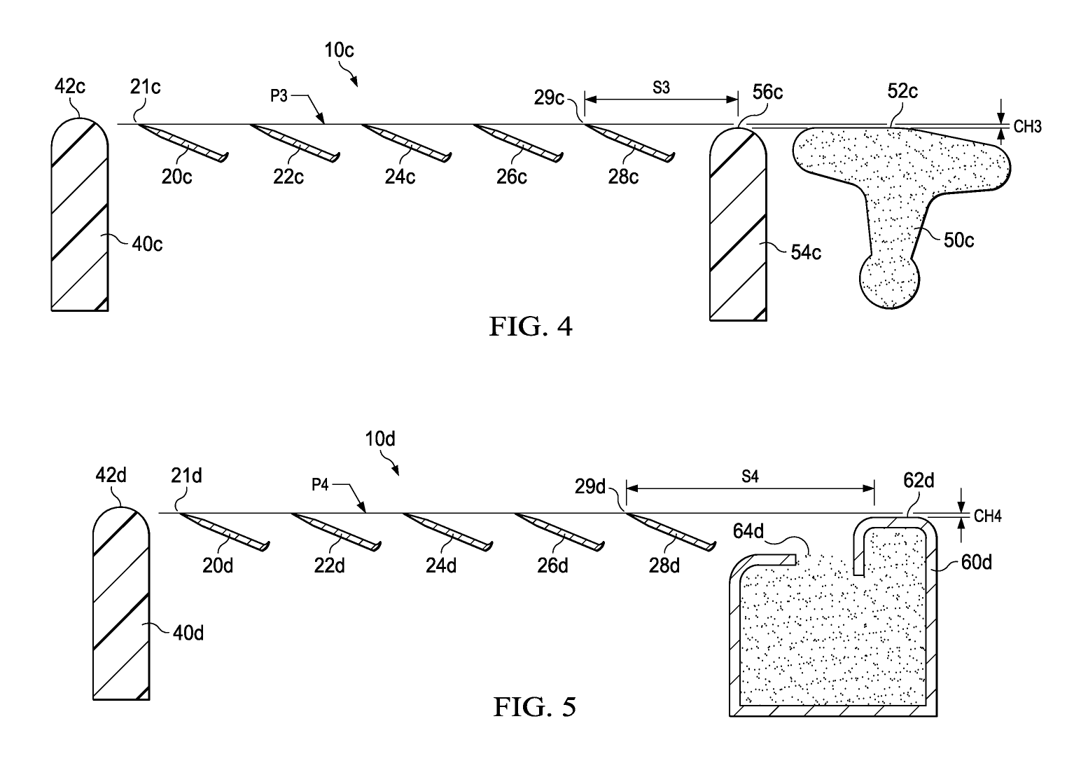

In certain embodiments, it may be desirable to have both a cap rail 54c and a cap 50c to provide more lubrication and glide during a shaving stroke. For example, the cap 50c may comprise a water soluble polymer, as previously described. Referring to FIG. 4, a schematic view of another possible embodiment of a shaving blade unit 10c is shown. The shaving blade unit 10c may be similar to the shaving blade unit 10b shown in FIG. 3; however the shaving blade unit 10c may have included both cap 50c and the cap rail 54c. The cap rail 54c may be spaced apart from the cap 50c. In certain embodiments, the cap rail 54c may be part of the housing 18 (not shown) or a separate component. The shaving blade unit 10c may include a guard 40c having an apex 42c (i.e., the highest point of the guard 40c). A leading blade 20c may be mounted to the housing 18 (not shown) nearest the guard 40c. A trailing blade 28c may be mounted to the housing nearest the cap rail 50c. The cap rail 54c may have a crest 56c (i.e., the highest point of the cap rail 54c). One or more intermediate blades 22c, 24c, 26c may be mounted to the housing 18 between the leading blade 20c and the trailing blade 28c. The blades 20c, 22c, 24c, 26c and 28c may be sprung mounted or fixed to the housing 18. The leading blade 20c and the trailing blade 28c may define a blade plane “P3” tangent to the blade edge 21c of the leading blade 20c and the blade edge 29c of the trailing blade 28c.

The cap rail 54c may have a cap span “S3” from the blade edge 29b of the trailing blade 28c to the crest 56c of the cap rail 54c. The cap span S3 may be taken from the point of the crest 56c that is nearest the trailing blade 28c. For example, the crest 52c and the crest 56c of the cap rail 54c may have the same height. Accordingly the cap span S3 is measured from the crest 56 of the cap rail 54c. The cap rail 54c may have a cap height “CH3” from the crest 56c to the blade plane P3, wherein a ratio of the cap span S3 to the cap height CH3 may be about 25 to about 70 (i.e., cap span S3 divided by cap height CH3).

In certain embodiments, the ratio of the cap span S3 to the cap height CH3 may be about 35 to 45 and more preferably about 38 to 42. In certain embodiments, the ratio of the cap span S3 to the cap height CH3 may be expressed as an absolute number. Accordingly, the crest 56c may be above the blade plane P3 or below the blade plane P3, but may have the same ratio. It is believed, without being held to theory, the ratio of the ratio of the cap span S3 to the cap height CH3, provides similar shaving benefits as previously described. The combination of the cap rail 54c and the cap 50c may have the additional benefit of providing more lubrication and maintaining the ratio of the cap span S2 to the cap height CH2 throughout the life of the shaving blade unit.

Referring to FIG. 5, a schematic view of another possible embodiment of a shaving blade unit 10d is shown. The shaving blade unit may have a guard 40d having an apex 42d. A leading blade 20d may be mounted to the housing 18 (not shown) nearest the guard 40d. The shaving blade unit 10d may be similar to the shaving blade unit 10a of FIG. 1. However the shaving blade unit 10d may comprise a reservoir housing 60d for setting the cap geometry. The reservoir 60d may contain one or more shaving aid composites, as previously described. A trailing blade 28d may be mounted to the housing nearest the reservoir housing 60d. One or more intermediate blades 22d, 24d and 26d may be mounted to the housing 18 between the leading blade 20d and the trailing blade 28d. The blades 20d, 22d, 24d, 26d, 28d may be sprung mounted or fixed to the housing 18. The reservoir housing 60d may have a crest 62d (i.e., the highest point of the reservoir housing 60d).

The leading blade 20d and the trailing blade 28d may define a blade plane “P4” tangent to the blade edge 21d of the leading blade 20d and the blade edge 29a of the trailing blade 28d. The reservoir housing 60d may have a cap span “S4” from the blade edge 29d of the trailing blade 28d to the crest 62d of the reservoir housing 60d. The cap span S4 may be taken from the point of the crest 62d that is nearest the trailing blade 28d, for example, if there are multiple crests having the same height, or if the crest 62d is long and flat. The reservoir housing 60d may have a cap height “CH4” from the crest 62d to the blade plane P4, wherein a ratio of the cap span S4 to the cap height CH4 may be about 25 to about 70 (i.e., cap span S1 divided by cap height CH1).

In certain embodiments, the ratio of the cap span S4 to the cap height CH4 may be about 35 to 45 and more preferably about 38 to 42. In certain embodiments, the ratio of the cap span S4 to the cap height CH4 may be expressed as an absolute number. Accordingly, the crest 62d may be above the blade plane P4 or below the blade plane P4, but may have the same ratio. It is believed, without being held to theory, the ratio of the ratio of the cap span S4 to the cap height CH4, provides similar shaving performance benefits as previously described.

In certain embodiments, the reservoir housing 60d may contain one or more a water soluble polymers (such as those previously described) that may absorb water and swell out of one or more openings 64d defined by the reservoir housing 60d. Since the water soluble polymer may swell depending on its composition, the geometry (e.g., the ratio of the cap span S4 to the cap height CH4) may be maintained by the crest 62d (i.e., the crest 62d may be above the opening 64d). In certain embodiments, the opening 64d may be in front of the crest 62d, as shown in FIG. 5. The ratio of the cap span S4 to the cap height CH4 make be taken in a dry condition (e.g., prior to use) and the water soluble polymers may swell above the crest 62d. In certain embodiments, the ratio of the cap span S4 to the cap height CH4 may be about 25 to about 70, about 35 to about 45 about 38 about to about 42 in both the dry condition (e.g., prior to shaving). Accordingly, the shaving blade unit 10 may produce a close, comfortable shave at the very beginning of the shave and toward the end of the shave after the cap 24 has absorbed water and swelled.

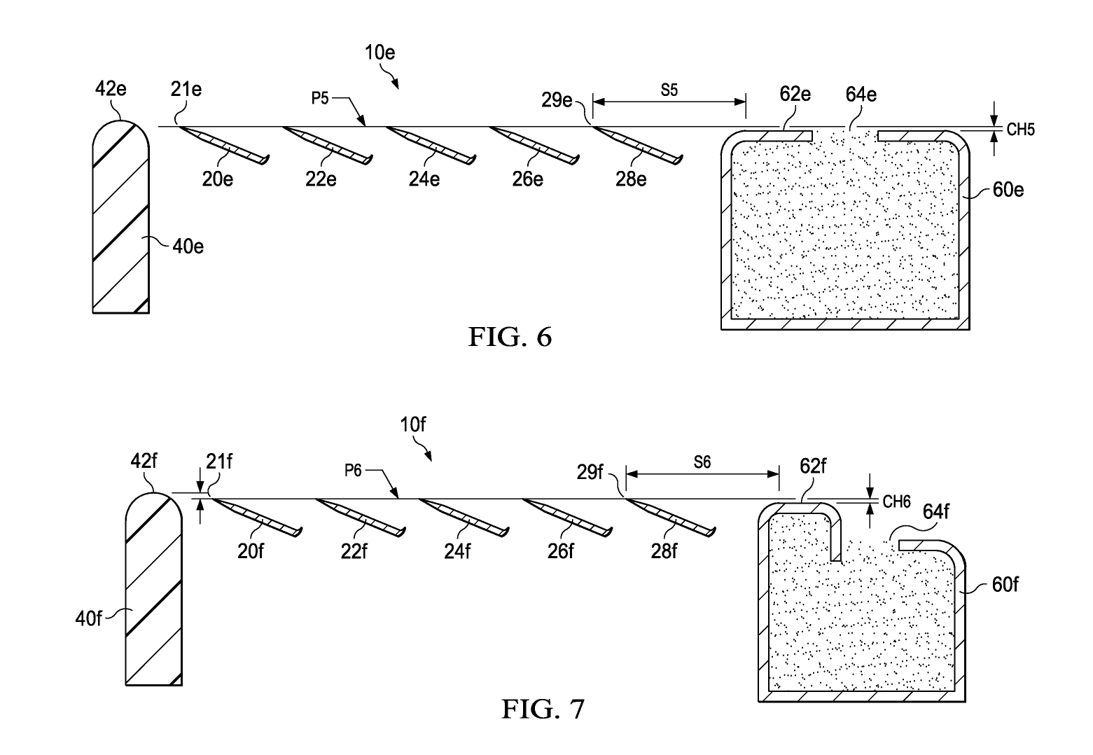

Referring to FIG. 6, a schematic view of another possible embodiment of a shaving blade unit 10e is shown. The shaving blade unit 10e may be similar to the shaving blade unit 10d shown in FIG. 5. However, the shaving blade unit 10e may comprise a reservoir housing 60e having a crest 62e (i.e., the highest point of the reservoir housing 60e) that is on the same plane as an opening 64e defined by the reservoir housing 60e. The crest 62e may be in front of the opening 64e defined by the reservoir opening 60e. The shaving blade unit 10e may have a guard 40e having an apex 42e. A leading blade 20e may be mounted to the housing 18 (not shown) nearest the guard 40e. A trailing blade 28e may be mounted to the housing 18 nearest the reservoir housing 60e. One or more intermediate blades 22e, 24e and 26e may be mounted to the housing 18 between the leading blade 20e and the trailing blade 28e. The blades 20e, 22e, 24e, 26e, 28e may be sprung mounted or fixed to the housing 18.

The leading blade 20e and the trailing blade 28e may define a blade plane “P5” tangent to the blade edge 21e of the leading blade 20e and the blade edge 29e of the trailing blade 28e. The reservoir housing 60e may have a cap span “S5” from the blade edge 29e of the trailing blade 28e to the crest 62e of the reservoir housing 60e. The cap span S5 may be taken from the point of the crest 62e that is nearest the trailing blade 28e, for example, if there are multiple crests having the same height, or if the crest 62e is long and flat. The reservoir housing 60e may have a cap height “CH5” from the crest 62d to the blade plane P5, wherein a ratio of the cap span S5 to the cap height CH5 may be about 25 to about 70 (i.e., cap span S5 divided by cap height CH5). In certain embodiments, the ratio of the cap span S5 to the cap height CH5 may be about 35 to 45 and more preferably about 38 to 42. In certain embodiments, the ratio of the cap span S5 to the cap height CH5 may be expressed as an absolute number. Accordingly, the crest 62e may be above the blade plane P5 or below the blade plane P5, but may have the same ratio. It is believed, without being held to theory, the ratio of the ratio of the cap span S5 to the cap height CH5, provides similar shaving performance benefits as previously described.

In certain embodiments, the reservoir housing 60e may contain one or more a water soluble polymers (such as those previously described) that may absorb water and swell out of one or more openings 64e defined by the reservoir housing 60e. Since the water soluble polymer may swell depending on its composition, the geometry (e.g., the ratio of the cap span S5 to the cap height CH5) may be maintained by the crest 62e (e.g., the crest 62e may be at the same level as the opening 64e. In certain embodiments, the opening 64e may be behind the crest 62e, as shown in FIG. 6. The ratio of the cap span S5 to the cap height CH5 make be taken in a dry condition (e.g., prior to use) and the water soluble polymers may swell above the crest 62e. In certain embodiments, the ratio of the cap span S5 to the cap height CH5 may be about 25 to about 70, about 35 to about 45 about 38 about to about 42 in both the dry condition and a wet condition (e.g., during shaving) because the cap height CH5 may not be impacted by shaving as may be the case with non housing reservoir embodiments. Accordingly, the shaving blade unit 10e may produce a close, comfortable shave at the very beginning of the shave and toward the end of the shave after the shaving aid within the reservoir housing has been depleted.

Referring to FIG. 7, a schematic view of another possible embodiment of a shaving blade unit 10f is shown. The shaving blade unit 10f may be similar to the shaving blade unit 10d shown in FIG. 5. However, the shaving blade unit 10f may comprise a reservoir housing 60f having a crest 62f (i.e., the highest point of the reservoir housing 600 that is in front of and above an opening 64f defined by the reservoir housing 60f.

The shaving blade unit 10f may have a guard 40f having an apex 42f. A leading blade 20f may be mounted to the housing 18 (not shown) nearest the guard 40f. A trailing blade 28f may be mounted to the housing 18 nearest the reservoir housing 60f. One or more intermediate blades 22f, 24f and 26f may be mounted to the housing 18 between the leading blade 20f and the trailing blade 28f. The blades 20f, 22f, 24f, 26f, 28f may be sprung mounted or fixed to the housing 18.

The leading blade 20f and the trailing blade 28f may define a blade plane “P6” tangent to the blade edge 21f of the leading blade 20f and the blade edge 29f of the trailing blade 28f. The reservoir housing 60f may have a cap span “S6” from the blade edge 29f of the trailing blade 28f to the crest 62f of the reservoir housing 60f. The cap span S6 may be taken from the point of the crest 62f that is nearest the trailing blade 28f, for example, if there are multiple crests having the same height, or if the crest 62f is long and flat. The reservoir housing 60f may have a cap height “CH6” from the crest 62f to the blade plane P6, wherein a ratio of the cap span S6 to the cap height CH6 may be about 25 to about 70 (i.e., cap span S6 divided by cap height CH6).

In certain embodiments, the ratio of the cap span S6 to the cap height CH6 may be about 35 to 45 and more preferably about 38 to 42. In certain embodiments, the ratio of the cap span S6 to the cap height CH6 may be expressed as an absolute number. Accordingly, the crest 62f may be above the blade plane P6 or below the blade plane P6, but may have the same ratio. It is believed, without being held to theory, the ratio of the ratio of the cap span S6 to the cap height CH6, provides similar shaving performance benefits as previously described.

In certain embodiments, the reservoir housing 60f may contain one or more a water soluble polymers (such as those previously described) that may absorb water and swell out of one or more openings 64f defined by the reservoir housing 60f. Since the water soluble polymer may swell depending on its composition, the geometry (e.g., the ratio of the cap span S6 to the cap height CH6) may be maintained by the crest 62f. (e.g., the crest 62f may be above the opening 64f. In certain embodiments, the opening 64f may be behind the crest 62f. The ratio of the cap span S6 to the cap height CH6 make be taken in a dry condition (e.g., prior to use) and the water soluble polymers may swell up to or above the crest 62e. In certain embodiments, the ratio of the cap span S5 to the cap height CH5 may be about 25 to about 70, about 35 to about 45 about 38 about to about 42 in both the dry condition and a wet condition (e.g., during shaving) because the cap height CH6 may not be impacted by shaving as may be the case with non housing reservoir embodiments. Accordingly, the shaving blade unit 10f may produce a close, comfortable shave at the very beginning of the shave and toward the end of the shave after the shaving aid within the reservoir housing has been depleted.

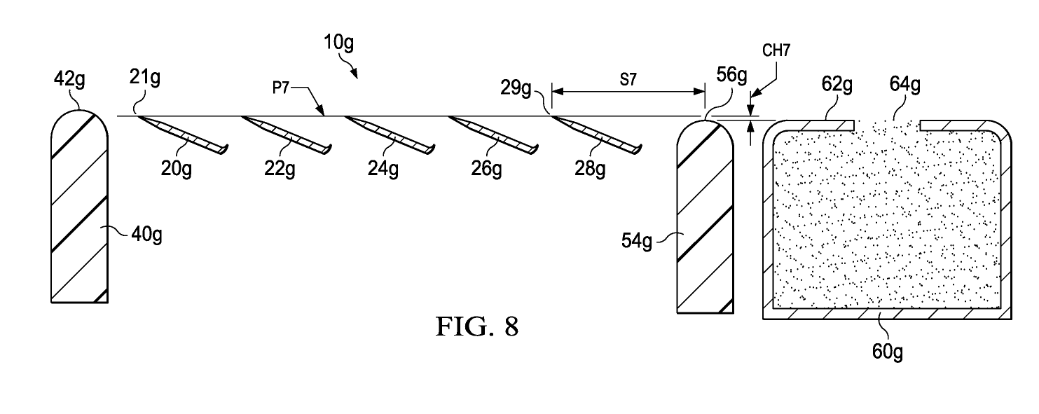

Referring to FIG. 8, a schematic view of another possible embodiment of a shaving blade unit 10g is shown. The shaving blade unit 10g may be similar to the shaving blade unit 10g shown in FIG. 3; however the shaving blade unit 10g may have a cap rail 54g and a reservoir housing 60g. The cap rail 54g may be manufactured from metal or plastic. In certain embodiments, the cap rail 54g may be part of the housing 18 (not shown) or a separate component. The shaving blade unit 10 may include a guard 40g having an apex 42g (i.e., the highest point of the guard 40g). A leading blade 20g may be mounted to the housing 18 (not shown) nearest the guard 40g. A trailing blade 28g may be mounted to the housing nearest the cap rail 54g. The cap rail 54g may have a crest 56g (i.e., the highest point of the cap rail 54g). One or more intermediate blades 22g, 24g, 26g may be mounted to the housing 18 between the leading blade 20g and the trailing blade 28g. The blades 20g, 22g, 24g, 26g and 28g may be sprung mounted or fixed to the housing 18. The leading blade 20g and the trailing blade 28g may define a blade plane “P7” tangent to the blade edge 21g of the leading blade 20g and the blade edge 29g of the trailing blade 28g.

The cap rail 54g may have a cap span “S7” from the blade edge 29g of the trailing blade 28g to the crest 56g of the cap rail 54g. The cap span S7 may be taken from the point of the crest 56g that is nearest the trailing blade 28g, for example, if there are multiple crests having the same height, or if the crest 56g is long and flat. The cap rail 54g may have a cap height “CH7” from the crest 56g to the blade plane P7, wherein a ratio of the cap span S7 to the cap height CH7 may be about 25 to about 70 (i.e., cap span S2 divided by cap height CH2).

In certain embodiments, the ratio of the cap span S7 to the cap height CH7 may be about 35 to 45 and more preferably about 38 to 42. In certain embodiments, the ratio of the cap span S7 to the cap height CH7 may be expressed as an absolute number. Accordingly, the crest 56g may be above the blade plane P7 or below the blade plane P7, but may have the same ratio. It is believed, without being held to theory, the ratio of the ratio of the cap span S7 to the cap height CH7, provides similar shaving benefits as previously described. The cap rail 54g may have the additional benefit of maintaining the ratio of the cap span S7 to the cap height CH7 throughout the life of the shaving blade unit. For example, the cap height CH1 may decrease with use as the crest 52b gradually wears away after each shave.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor cartridge comprising:
a housing;
a guard toward a front of the housing;
a cap toward a rear of the housing, the cap having a crest;
a leading blade mounted to housing nearest the guard and a trailing blade mounted to the housing nearest the cap, each blade having a blade edge, the blades defining a blade plane tangent to the edge of the leading blade and the edge of the trailing blade, the cap having a cap span from the edge of the trailing blade to the crest and a cap height from the crest to the blade plane, wherein a ratio of the cap span to the cap height is about 25:1 to about 70:1.

2. The shaving razor cartridge of claim 1 wherein the crest is below the blade plane.

3. The shaving razor cartridge of claim 1 wherein the crest is above the blade plane.

4. The shaving razor cartridge of claim 1 wherein the cap comprises a cap rail.

5. The shaving razor cartridge of claim 3 further comprising a lubrication member comprising a water soluble polymer behind the cap rail.

6. The shaving razor cartridge of claim 4 wherein the cap rail is metallic.

7. The shaving razor cartridge of claim 1 wherein the crest comprises a water soluble polymer.

8. The shaving razor cartridge of claim 1 further comprising at least one additional blade mounted to the housing between the leading blade and the trailing blade.

9. The shaving razor cartridge of claim 1 further comprising at least two additional blades mounted to the housing between the leading blade and the trailing blade.

10. The shaving razor cartridge of claim 1 wherein the ratio of the cap span to the cap height is about 35:1 to about 45:1.

11. The shaving razor cartridge of claim 1 wherein the ratio of the cap span to the cap height is about 38:1 to about 42:1.

12. The shaving razor cartridge of claim 1 wherein the cap comprises a reservoir housing containing a water soluble polymer.

13. The shaving razor cartridge of claim 12 wherein the reservoir housing defines an opening for the water soluble polymer to swell.

14. The shaving razor cartridge of claim 13 wherein the water soluble polymer swells above the cap crest during use.

15. The shaving razor cartridge of claim 12 wherein the crest is forward of the opening.

16. The shaving razor cartridge of claim 12 wherein the crest is behind the opening.

17. The shaving razor cartridge of claim 12 wherein the crest is part of the reservoir housing.

18. The shaving razor cartridge of claim 1 wherein the blade edge of the trailing blade has a blade radius less than or equal to 300 A.

19. A shaving razor cartridge comprising:
a housing;
a guard toward a front of the housing;
a cap toward a rear of the housing, the cap having a crest comprising a water soluble polymer;
a leading blade mounted to housing nearest the guard and a trailing blade mounted to the housing nearest the cap, at least one additional blade mounted to the housing between the leading blade and the trailing blade, each blade having a blade edge, the leading blade and the trailing blade defining a blade plane tangent to the edge of the leading blade and the edge of the trailing blade, the cap having a cap span from the edge of the leading blade to the crest and a cap height from the crest to the blade plane, wherein a ratio of the cap span to the cap height is about 38:1 to about 42:1, wherein the crest is below the blade plane.

20. The shaving razor cartridge of claim 19 wherein the blades are sprung mounted to the housing.
